(19) United States
(12) Patent Application Publication
(10) Pub. No.: US 2007/0269780 A1
(43) Pub. Date: Nov. 22, 2007

(54) Learning aid

(76) Inventor: Sonya Bryant Miller, Wilson, NC (US)

Correspondence Address: PAUL H. DEMCHICK;PROFESSOR DEMCHICK'S PATENT SERVICES, THE JACOB TOMLINSON HOUSE, 407 WEST BROAD STREET, WILSON, NC, 27893, US

(21) Appl. No.: 11/746,623

(22) Filed: May 9, 2007

Related U.S. Application Data
(60) Provisional application No. 60/747,467, filed on May 17, 2006.

(51) Int. Cl. G09B 11/00

(52) U.S. Cl. 434/162

(57) ABSTRACT

Learning aid. The invention disclosed here is a system to aid the user in learning. The preferred embodiment is intended to aid the user in learning to write. Some embodiments of the invention disclosed here are printed sheets having a traceable pattern rendered in multiple colors, with each intended stroke indicated in a different color. In some, the pattern is a symbol which is part of a written language. In some, the symbol is a letter. In some, the symbol is a logogram. In some, the pattern is a symbol which is part of a mathematical notation. In some, the symbol is a numeral. Some include arrows indicating the direction in which strokes should be made. In some, there are printed numbers indicating an order in which strokes should be made. Some are systems having a printed sheet and a pocket capable of housing the printed sheet, the pocket having a transparent or translucent outer layer, the outer layer being capable of readily adhering conventional dry erase inks and the outer layer also readily able to dry-release the inks. In some, there is also a pouch suitable for the storage of dry erase markers. In some, the printed sheet has a traceable pattern rendered in a plurality of colors, with each intended stroke indicated in a different color. In some, there is also a pouch suitable for the storage of dry erase markers and further having a dry erase marker.

### CROSS-REFERENCE TO RELATED APPLICATIONS

This application claims priority from U.S. Provisional Application No. 60/747,467 filed on 17 May 2006 entitled “Learning Aid” which is incorporated by reference herein in its entirety.

### STATEMENT REGARDING FEDERALLY SPONSORED RESEARCH OR DEVELOPMENT REFERENCE TO SEQUENCE LISTING, A TABLE, OR A COMPUTER PROGRAM LISTING COMPACT DISK APPENDIX

Not applicable

### BACKGROUND OF THE INVENTION

One of the fundamental skills required to learn to handwrite in the conventional manner is to learn the appropriate stroke pattern to form the individual characters. This is true for both logographic and phonetic writing systems. That is true if one is learning to write one's first language or another language. Many systems and methods have been developed to aid the learning of character writing. However, none has proven fully satisfactory for all circumstances.

In educational settings, it is common for single-use worksheets to be used. That can, among other problems, be expensive. It is also often impractical to duplicate such worksheets in color.

### BRIEF SUMMARY OF THE INVENTION

The invention disclosed here is a system to aid the user in learning. The preferred embodiment is intended to aid the user in learning to write. Features of the preferred embodiment of the invention include traceable patterns that include colors to indicate distinct strokes to be made when forming characters and a system which allows tracing of inserted patterns which are housed below a transparent dry-erase covering.

### BRIEF DESCRIPTION OF THE DRAWINGS

FIG. 1 is a detailed depiction of the letter “A” as on one insert of the preferred embodiment of the invention disclosed here.

FIG. 2 is a depiction of the letter “G” as on one insert of the preferred embodiment of the invention disclosed here.

FIG. 3 depicts one insert of the preferred embodiment of the invention disclosed here.

FIG. 4 depicts one insert of the preferred embodiment of the invention disclosed here.

FIG. 5 depicts one insert of the preferred embodiment of the invention disclosed here.

FIG. 6 includes six views. Those views depict the binder of the preferred embodiment of the invention disclosed here and inserts of the preferred embodiment of the invention disclosed here.

FIG. 7 depicts the binder of the preferred embodiment of the invention disclosed here.

FIG. 8 is a depiction of the numeral “4” as on one insert of the preferred embodiment of the invention disclosed here.

FIG. 9 is a depiction of the cursive “F” as on one insert of the preferred embodiment of the invention disclosed here.

FIG. 10 is a detailed depiction of the letter “A” as on one insert of an alternative embodiment of the invention disclosed here.

### DETAILED DESCRIPTION OF CERTAIN EMBODIMENTS OF THE INVENTION

It should be noted that the use of color is a key feature of certain embodiments of the invention disclosed here (including, but not limited to, the preferred embodiment of the invention disclosed here). In order to depict colors in selected black and white figures, patterns are used as surrogates for color. Each dot pattern in a given figure is used to represent a different color. In the actual invention, colors are used instead of those patterns.

The term “dry erase ink” is used in this disclosure in reference to dry-erase pigment systems. That term is used in the broad, commonly used sense, to include any mixture or solution used to impart dry erasable pigment regardless of the specific composition or nature.

The preferred embodiment of the invention disclosed here is a system which includes a dry erase marker, a binder with two pockets with clear outer layers, and several inserts.

The dry erase marker of the preferred embodiment is a fine tip dry erase marker of the conventional type. It delivers dry erase ink to a surface.

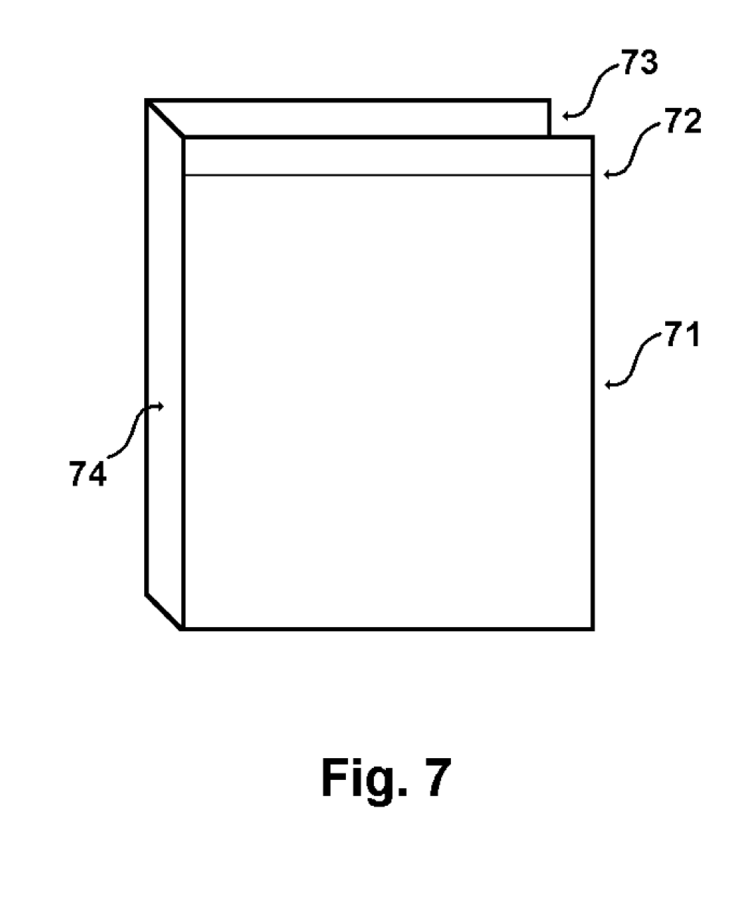

The binder in the preferred embodiment is a one inch nominal thickness, standard sized loose-leaf binder of the conventional type. The binder has plastic rings instead of metal rings for increased safety when used by young children. The front and back covers each have a transparent plastic outer layer which is attached to the rest of the cover on each side and the bottom, but not the top. That transparent layer is approximately the width of the cover, but slightly less tall than the cover. That transparent layer when attached to the rest of the cover forms a pocket. An insert placed in one of those pockets can be seen through the transparent layer. That transparent layer is a plastic to which the dry erase marker can readily, but temporarily, adhere. The marking can then be readily dry-wiped from the layer. FIG. 7 depicts the binder of the preferred embodiment of the invention disclosed here. The depiction includes a back cover 73, side cover 74, and front cover 71. The top edge 72 of the transparent layer attached to the front cover is indicated.

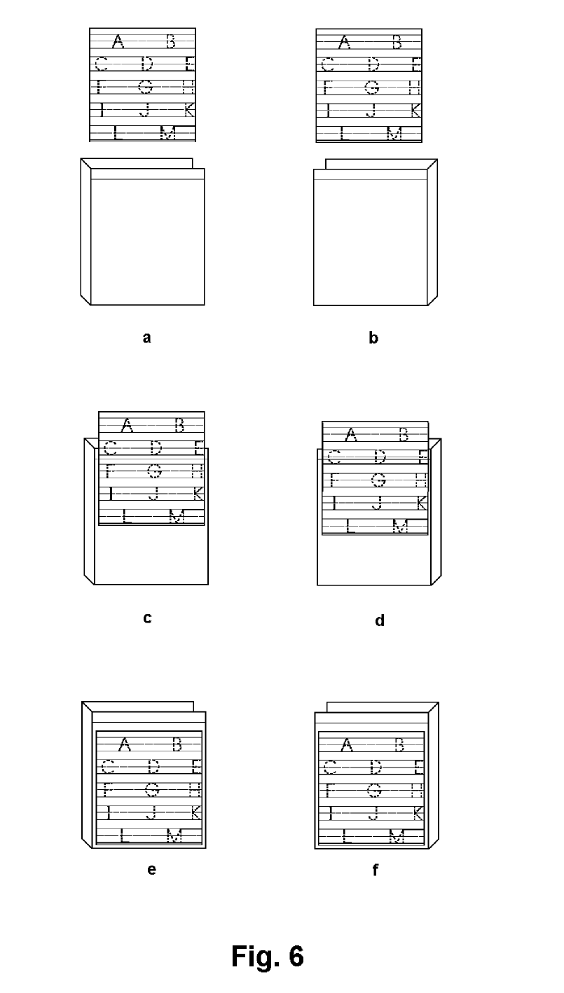

FIG. 6 includes six views. Views “a,” “c,” and “e” include a depiction of the binder with the front cover of the binder facing the viewer. Views “b,” “d, and “f” include a depiction of the binder with the back cover of the binder facing the viewer. Views “a” and “b” each depict a binder and an insert sheet. Views “c” and “d” each depict an insert part way inserted into a pocket. Views “e” and “f” each depict an insert fully inserted into a pocket.

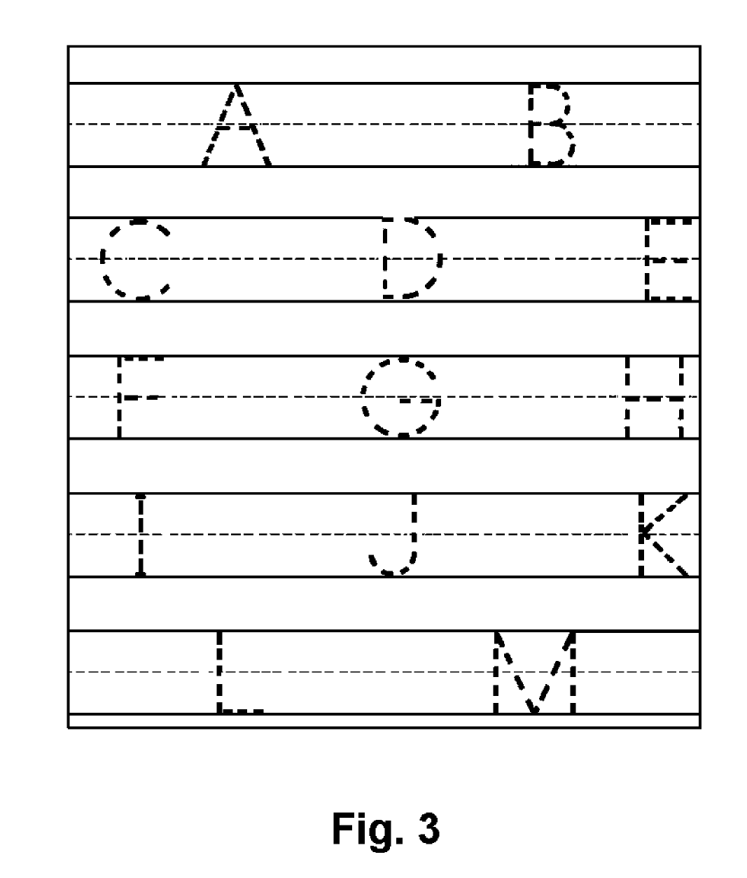

FIG. 3 depicts one of the inserts of the preferred embodiment of the invention disclosed here. The letters (printed “A” through “M”) shown on the insert are printed using multiple colors (as described in more detail elsewhere in this disclosure). Each character is dashed and is intended to allow the learner to trace the pattern of the character.

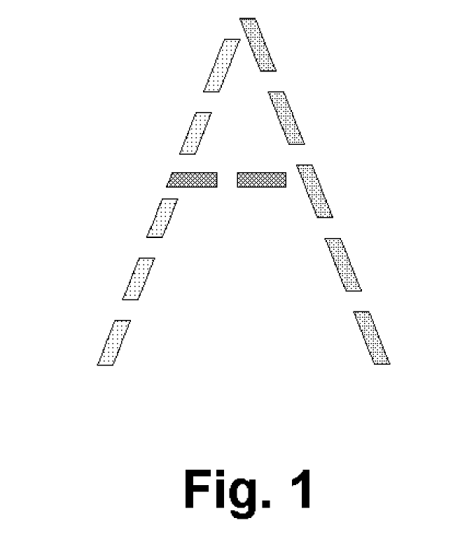

FIG. 1 is a more detailed depiction of the character “A” as depicted, in less detail, in FIG. 3. Color is a key feature of the preferred embodiment of the invention disclosed here. In order to depict colors in FIG. 1, patterns are used as surrogates for color. Each dot pattern in a given figure is used to represent a different color. In the actual invention, colors are used instead of those patterns. In the case of this letter, the two diagonals line segments and the horizontal line segment that make up the “A” are each a different color. Although other colors could be used in other embodiments of the invention disclosed here, in the preferred embodiment, the right diagonal line segment is purple, the left diagonal line segment is red and the horizontal line segment is green. Each line segment is dashed to facilitate the user tracing the pattern.

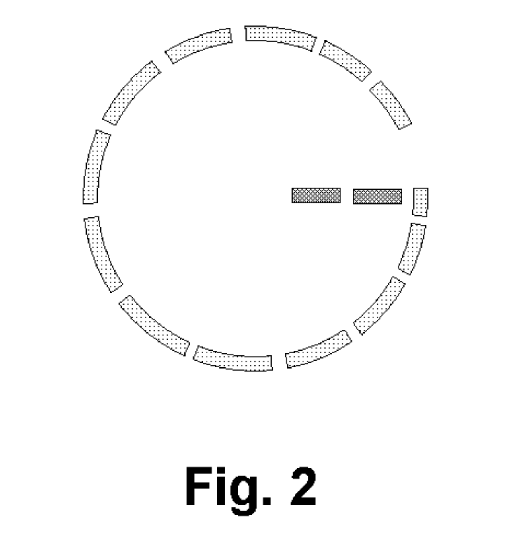

FIG. 2 is a more detailed depiction of the character “G” as depicted, in less detail, in FIG. 3. In order to depict colors in this black and white figure, patterns are used as surrogates for color. Each dot pattern in this figure is used to represent a different color. In the actual invention, colors are used instead of those patterns. In the case of this letter, the arc and the horizontal line segment that make up the “G” are each a different color. Although other colors could be used on other embodiments of the invention disclosed here, in the preferred embodiment, the curved arc is red and the horizontal line segment is green. The line segment and the arc are each dashed to facilitate the user tracing the pattern.

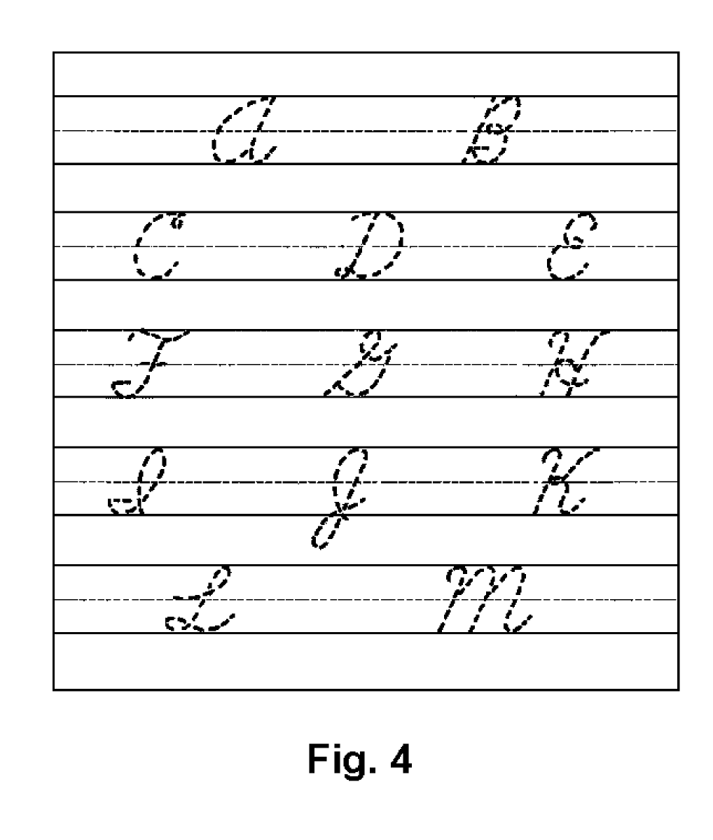

FIG. 4 depicts another of the inserts of the preferred embodiment of the invention disclosed here. The letters (cursive “A” through “M”) shown on the insert are printed using multiple colors (as described in elsewhere in this disclosure). However, each character is dashed and is intended to allow the learner to trace the pattern of the character.

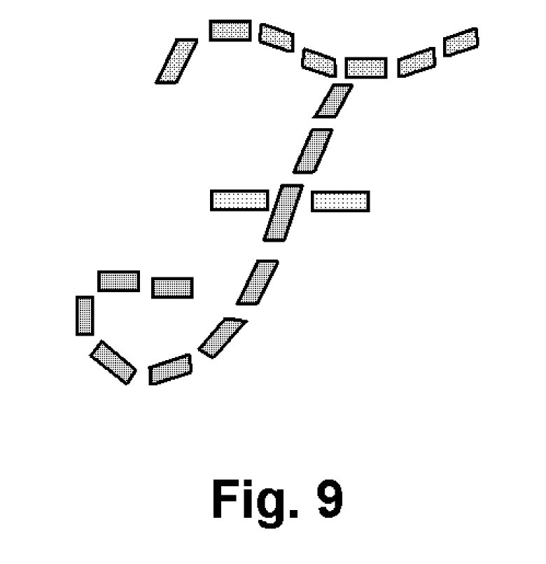

FIG. 9 is a more detailed depiction of the curving character “F” as depicted, in less detail, in FIG. 4. Color is a key feature of the preferred embodiment of the invention disclosed here. In order to depict colors in this black and white figure, patterns are used as surrogates for color. Each dot pattern in this figure is used to represent a different color. In the actual invention, colors are used instead of those patterns. In the case of this “F,” the three strokes used to form the character are each a different color. Although other colors could be used on other embodiments of the invention disclosed here, in the preferred embodiment, the center horizontal curve is red, the top curve is purple and the generally vertical curve is light blue. Each curve stroke is dashed to facilitate the user tracing the pattern.

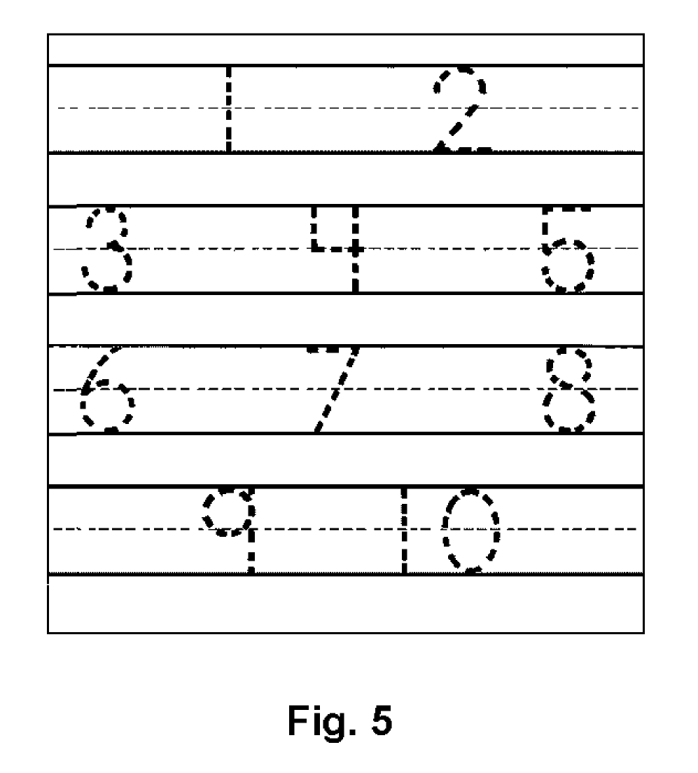

FIG. 5 depicts yet another of the inserts of the preferred embodiment of the invention disclosed here. Numbers (“1” through “10”) shown on the insert are printed using multiple colors (as described elsewhere in this disclosure). However, each character is dashed and is intended to allow the learner to trace the pattern of the character.

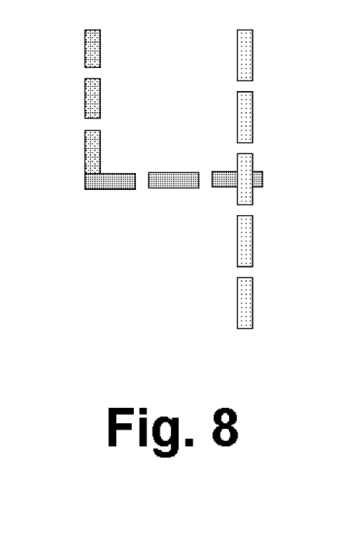

FIG. 8 is a more detailed depiction of the character “4” as depicted, in less detail, in FIG. 5. In order to depict colors in this black and white figure, patterns are used as surrogates for color. Each dot pattern in this figure is used to represent a different color. In the actual invention, colors are used instead of those patterns. In the case of this numeral, the two vertical line segments and the horizontal line segment that make up the “4” are each a different color. Although other colors could be used on other embodiments of the invention disclosed here, in the preferred embodiment, the right vertical line segment is blue, the left vertical line segment is green and the horizontal line segment is red. Each line segment is dashed to facilitate the user tracing the pattern.

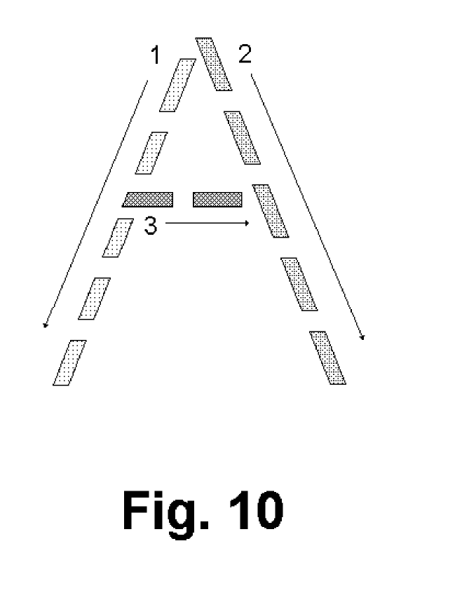

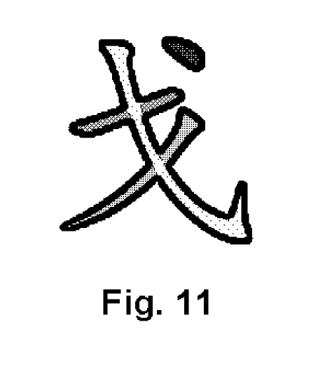

An alternative embodiment of the invention disclosed here is essentially the same as the preferred embodiment of the invention disclosed here except that the inserts include arrows and small numerals to indicate the appropriate stroke order and direction for each stroke. One example of such marked up character is depicted in FIG. 10. Similarly to 1, in order to depict colors in this black and white figure, patterns are used as surrogates for color. Each dot pattern in this figure is used to represent a different color. In the actual invention, colors are used instead of those patterns. In the case of this letter, the two diagonals line segments and the horizontal line segment that make up the “A” are each a different color. Although other colors could be used on other embodiments of the invention disclosed here, in this alternative embodiment, the right side diagonal line segment is purple, the left side diagonal line segment is red and the horizontal line segment is green. Each line segment is dashed to facilitate the user tracing the pattern. It should be notes that the three arrows and the three numeral (“1,” “2” and “3”) are actual pattern elements, not reference characters. In this alternative embodiment of the invention disclosed here, all of the characters have similar arrow and number markings to indicated stroke order and direction.

Although not all of the inserts are depicted in detail, the preferred embodiment of the invention disclosed here includes inserts with the end of the alphabet (“N” though “Z”) (printed and cursive) and the lower case letters (printed and cursive).

Although the use of color in embodiments of the invention disclosed here can improve the visual appeal, especially for young learners, the colors are not merely decorative. The colors aid the user in immediately recognizing distinct strokes used to form each letter.

Embodiments of the invention disclosed here are based on character sets other than the English language character set. Those embodiments could be other phonetic characters (i.e., letters), ideograms or logographic characters (i.e., logograms). Embodiments of the invention disclosed here could also be used to aid the learning of character sets that are not used for the written form of any natural language. Examples include, without limitation, musical notation symbols and mathematical notation symbols.

FIG. 11 is a depiction of a logogram in an embodiment of the invention disclosed here. Color is a key feature of that embodiment of the invention disclosed here. In order to depict colors in this black and white figure, patterns are used as surrogates for color. Each dot pattern in this figure is used to represent a different color. In the actual invention, colors are used instead of those patterns.

Certain embodiments of the invention disclosed here have some, but not all of the features of the embodiments described above. For example, there are embodiments similar to the preferred embodiment except that the inserts do not include multi-color printing. As another example, embodiments of the invention disclosed here could include the multicolor “inserts” as free-standing sheets without the binder (in those cases, the sheets would not truly be inserts, since they would not be inserted). As yet one more example, an embodiment could include the inserts and a pocket with a transparent layer similar to those the transparent layers on the binder of the preferred embodiment, but in which the pockets are not part of a binder.

There are embodiments of the invention disclosed here which are similar to the preferred embodiment, but which additionally has a pouch in the binder which allows the storage of dry erase marks.

In many languages, including English, there are numerous variations on the specific ways that specific characters are formed. However, a specific educator typically wants his or her students to form characters in a specific manner. It is practical for the inserts to be made in various styles to accommodate teacher preferences. It could also be practical for the inserts to be customized to meet the specific needs or preferences of a particular educator.

As a supplemental disclosure of certain aspects of certain embodiments of the invention disclosed here, information regarding images of the color printed pattern for selected sheets is included here as Base64 encoded .GIF files. The .GIF files can be created using commonly available base64 decoders and the .GIF files can be used to create images using commonly available software for that purpose. The included Base64 listings are bounded by quotation marks. It should be noted that those quotation marks are not, themselves, part of the encoded information.

The Base64 encoded .GIF image for a typical sheet of numbers which is an embodiment of the invention disclosed here is:

The Base 64 encoded .GIF image for a typical sheet of cursive letters which is an embodiment of the invention disclosed here is:

The Base encoded .GIF image for a typical sheet of printed letters which is an embodiment of the invention disclosed here is:

Alternative embodiments of the invention disclosed here could have inserts to assist in learning other than learning to write character sets. Examples include inserts with partially completed calendars for learners to complete, various worksheets, number lines and graph paper. These embodiments could significantly reduce the cost of duplicating or purchasing worksheets and the like. It would also make multi-color sheets practical.

An alternative embodiment of the invention disclosed here is similar to the preferred embodiment except that the outer layer of the pocket is translucent instead of transparent.

Alternative embodiments of the invention disclosed here could be similar to the preferred embodiment except that the binder would have different dimensions or configurations. By way ofexample, and not limitation, the binder could have a 2 inch nominal thickness. By way of another non-limiting example, the binder could have a pocket on the front cover, but not the back cover.

As another example of embodiments of the invention disclosed here to aid learning, the inserts could have unlabelled diagrams for the learner to label. Fields in which this could prove useful include, without limitation, anatomy.

Some embodiments of the invention disclosed here are printed sheets having a traceable pattern rendered in multiple colors, with each intended stroke indicated in a different color. In some, the pattern is a symbol which is part of a written language. In some, the symbol is a letter. In some, the symbol is a logogram. In some, the pattern is a symbol which is part of a mathematical notation. In some, the symbol is a numeral. Some include arrows indicating the direction in which strokes should be made. In some, there are printed numbers indicating an order in which strokes should be made. Some are systems having a printed sheet and a pocket capable of housing the printed sheet, the pocket having a transparent or translucent outer layer, the outer layer being capable of readily adhering conventional dry erase inks and the outer layer also readily able to dry-release the inks. In some, there is also a pouch suitable for the storage of dry erase markers. In some, the printed sheet has a traceable pattern rendered in a plurality of colors, with each intended stroke indicated in a different color. In some, there is also a pouch suitable for the storage of dry erase markers and further having a dry erase marker.

In addition to other benefits, certain embodiments of the invention disclosed here has the benefit of adding novelty and interest for the user. This can significantly increase the concentration and attentiveness of the learner, thereby improving the learning process.

From the above description and drawings, it will be understood by those of ordinary skill in the art that the particular embodiments shown and described are for purpose of illustration only, and are not intended to limit the scope of the invention. Those of ordinary skill in the art will recognize that the invention may be embodied in other specific forms without departing from its spirit or essential characteristics. References to details of particular embodiments are not intended to limit the scope of the claims.

No claim element herein is to be construed under the provisions of 35 U.S.C. § 112, sixth paragraph, unless the element is expressly recited using the phrase “means for” or “step for.”

The invention claimed is:

1. A printed sheet comprising a traceable pattern rendered in a plurality of colors, with each intended stroke indicated in a different color.

2. A printed sheet as in claim 1 in which said pattern is a symbol which is part of a written language.

3. A printed sheet as in claim 2 in which said symbol is a letter.

4. A printed sheet as in claim 2 in which said symbol is a logogram.

5. A printed sheet as in claim 1 in which said pattern is a symbol which is part of a mathematical notation.

6. A printed sheet as in claim 5 in which said symbol is a numeral.

7. A printed sheet as in claim 1 in which printing also included arrows indicating the direction in which strokes should be made.

8. A printed sheet as in claim 1 in which printing includes numbers indicating an order in which strokes should be made.

9. A system comprising a printed sheet and a pocket capable of housing said printed sheet, said pocket comprising a transparent or translucent outer layer, said outer layer being capable of readily adhering conventional dry erase inks and said outer layer also readily able to dry-release said inks.

10. A system as in claim 9 further comprising a pouch suitable for the storage of dry erase markers.

11. A system as in claim 9 in which said printed sheet comprises a traceable pattern rendered in a plurality o f colors, with each intended stroke indicated in a different color.

12. A system as in claim 11 further comprising a pouch suitable for the storage of dry erase markers and further comprising a dry erase marker.
